(19) United States
(12) Patent Application Publication
(10) Pub. No.: US 2024/0149699 A1
(43) Pub. Date: May 9, 2024

(54) SYSTEM FOR ELECTRICALLY FEEDING ELECTRICALLY POWERED VEHICLES

(71) Applicant: BluVein Innovation AB, Northgate (AU)

(72) Inventors: Oliver James, Ascot (AU); Anthony Sprague, Warrandyte (AU); Gunner Asplund, Solna (SE)

(73) Assignee: BluVein Innovation Pty. Ltd., Northgate, QL (AU)

(21) Appl. No.: 18/550,073

(22) PCT Filed: Mar. 12, 2021
(86) PCT No.: PCT/EP2021/056376

§ 371 Date: Sep. 11, 2023

(51) Int. Cl. B60L 9/00; B60L 5/40; B60L 50/53; B60L 53/63; B60L 53/66

(52) U.S. Cl. CPC B60L 9/00; B60L 5/40; B60L 50/53; B60L 53/63; B60L 53/66; B60L 2200/40; B60L 2240/12

(57) ABSTRACT

System (1) for electrically feeding electrically powered vehicles (2a-b), comprising electric conductor(s) (3) extending along a road section (4) and a central electronic control unit, CECU (8). The vehicles comprise a current collector (5a-b), an onboard energy storage device (7a-b) and a thereto connected vehicle electronic control unit, VECU (6a-b). The VECU is configured to determine a current required power and a current energy storage status, and to send a signal to the CECU indicating the current required power and the energy storage status. The CECU is configured to determine a maximum power available via said electric conductor and a power to be received for each vehicle such that the maximum power is not exceeded and send at least one power control signal to each VECU indicating the power to be received. The VECU is configured to control received power in response to said at least one power control signal.

### TECHNICAL FIELD

The invention relates to the field of electrical feeding of vehicles, and in particular electrical feeding of heavy trucks and mining/underground vehicles.

### BACKGROUND

Concerns about the environmental impact of combustion of fossil fuels have led to an increased interest in electric vehicles, which have several potential benefits compared to vehicles with conventional internal combustion engines, including: a significant reduction of air pollution, as they do not emit harmful tailpipe emissions, reduced greenhouse gas emissions (depending on the fuel and technology used for electricity generation and/or charging the batteries) and reduced dependency on fossil fuels with increasingly variable supply and fluctuating prices. In underground applications such as mines, air pollution is particularly problematic.

One disadvantage to be overcome is the limited range of existing electric vehicles due to limitations in battery capacity. This is a particularly significant disadvantage for heavy vehicles such as long haulage trucks as well as construction and mining vehicles.

WO 2010/140964 proposes a solution to this problem by feeding electric vehicles while driving. It discloses a system for electric propulsion of a vehicle along a road comprising electric conductors arranged in slotted elements which may be located in longitudinal tracks or channels in the road. The vehicle is equipped with a current collector which during contact with the slotted element allows for transfer of electric current between the conductors and the vehicle.

WO 2016/174030 discloses a system for electrical feeding of a vehicle in an underground environment such as a mine. The electrical feeding is used to propel the vehicle directly and/or to charge an onboard battery. The system comprises at least one elongated slotted element having at least one slot or groove in which electric conductors are arranged. The slotted element is suspended for example from the ceiling in the mine tunnels, and a current collector connects the vehicle electrically to the slotted element.

Such systems are advantageous since they not only provide low emissions, reduced need for battery capacity, but also good safety properties due to the slotted electric conductors. One problem is that the maximum power available at a given location along the road or mining tunnel may be insufficient to meet the requirements of the vehicles at said location. This problem may occur during so called “platooning”, where several heavy trucks drive extremely close on highways to reduce air resistance, thus demanding high power over a relatively short length of the road. The problem may also occur in mining applications, where the vehicles typically carry very heavy loads and travel up steep tunnels, thus requiring high power.

One solution to this problem is to increase the power feed to the slotted element and/or to increase the cross-section of the electric conductors in the slotted elements. An obvious disadvantage with these solutions is increased cost.

### SUMMARY

An object of the invention is to solve or improve on at least some of the problems mentioned above in the background section.

These and other objects are achieved by the present invention by means of a system and method according to the independent claims.

According to a first aspect of the invention, there is provided a system for electrically feeding at least one electrically powered vehicle, comprising at least one electric conductor adapted to be electrically energized and extending along a road section on which the at least one vehicle is adapted to travel, at least two electrically powered vehicles and a central electronic control unit, CECU. The CECU may be electrically connected to said at least one electric conductor. At least two of the electrically powered vehicles comprises at least one current collector adapted to connect the vehicle electrically to said at least one electric conductor, and a vehicle electronic control unit, VECU, being electrically connected to said current collector, said VECU being directly or indirectly connected to an onboard energy storage device of said vehicle, for instance a battery set. The VECU and CECU are configured for communication with each other, preferably two-way communication. Each VECU is configured to determine a current required power for propulsion of the vehicle and a current energy storage status of said energy storage device, for instance a battery charge status of a battery set, and to send at least one signal to the CECU indicating said current required power and said energy storage status. The CECU is configured to determine a maximum power available from said electric conductor, and to, based on said at least one signal from each VECU, determine a power to be received for each vehicle such that the maximum power is not exceeded, and send at least one power control signal to each VECU indicating said power to be received. The VECU is furthermore configured to control received power via the current collector in response to said at least one power control signal.

The invention is based on the insight that by having a central electronic control unit, CECU, having information regarding the power requirements and the onboard energy storage status of each vehicle at any given time, and being able to control the power draw for each vehicle from the electric conductor, an overall optimized operation of the system is possible, where each vehicle may propel, for instance at a desired target speed, without exceeding the maximum allowable power from the electric conductor. The invention is further based on the insight that such information regarding the vehicles and control of the vehicles may be achieved by providing each vehicle with a vehicle electronic control unit, VECU, which is arranged in communication with the CECU. By having information regarding not only the power requirement for each vehicle but also the onboard energy storage status, the CECU may for example send a power control signal indicating a power to be received being lower than the required power for propulsion (for instance at the target speed) to vehicles having sufficient energy storage status to compensate for the lower received power, while vehicles with lower energy storage status are sent a power control signal indicating a higher power to be received. In other words, the invention may be described as a load control arrangement for the electric conductor where a power to be received for each vehicle is determined such that the maximum power of the electric conductor is not exceeded. The power to be received may furthermore be determined such that the vehicle maintains a target speed.

It is understood that the at least one electric conductor extends along a road section on which the at least one vehicle is adapted to travel in the sense that it is substantially parallel with a longitudinal direction of the road section. Further, the at least one electric conductor may be arranged on the road surface, partly or wholly recessed in one or more grooves in the road surface, or may be suspended above the road surface, for instance at a height such that it is located above the vehicles or a lateral side of the vehicles. It is furthermore understood that the term road section refers to any type of surface on which the at least one electrically powered vehicle is adapted to travel, including not only roadways but also bottom surfaces of mining tunnels. It is furthermore understood that the at least two of the electrically powered vehicles having a current collector are each configured to be electrically propellable by means of electric power from its current collector and/or from the onboard energy storage device. It is furthermore understood that the VECU being indirectly connected to a battery set implies that it can be indirectly connected to the battery set via for example a battery management system (BMS), which is arranged to monitor the charge status and health status of each battery cell of the battery set. Alternatively, such functionality may be part of the VECU, and the VECU may be directly connected to the battery set. It is furthermore understood that the target speeds for the vehicles do not necessarily need to be constant or predetermined but may be varied for instance by the vehicle operator, or in embodiments, by the CECU. It is furthermore understood that the maximum available power from the electric conductor is the maximum power obtainable from the electric conductor. This maximum power may be determined for instance from a set of predetermined values, for instance in the form of a look-up table, which values may be adjustable by means of a user interface connectable to the CECU, or by means of a configuration file loadable into the CECU. Alternatively, the maximum power available may be determined by one or more measurements on the electric conductor.

In embodiments, the onboard energy storage device is a battery set, and the energy storage status is the battery charge status. It is understood that the onboard energy storage device may alternatively be any other type of energy storage device which stores electrical energy or stores energy in another form which may be converted to and/or from electrical energy. The energy storage device may thus for example be a device storing energy in electrochemical, electromagnetic, pressure, potential, kinetic, chemical or thermal form. Examples include, but are not limited to hydraulic accumulators, flywheels, capacitors and fuel cells.

In embodiments, each VECU is configured to determine a current required power for propulsion of the vehicle at a target speed. This allows the CECU to determine the power to be received for each vehicle such that the maximum power is not exceeded while each vehicle maintains its target speed.

In embodiments, the CECU is stationary, i.e., is located at a fixed location and is electrically connected to the (also) stationary electric conductor.

In embodiments, at least one of said at least one electric conductor is formed by consecutively arranged conductor segments, i.e. the at least one electric conductor is divided in its lengthwise direction into conductor segments, wherein the CECU is configured to determine which conductor segment or segments the vehicles are connected to, and to determine a maximum power available via said conductor segment or segments, and to determine said power to be received for each vehicle such that the maximum power for each conductor segment is not exceeded. The power to be received may be determined such that the maximum power for each conductor segment is not exceeded while each vehicle maintains its target speed. For example, if the sum of the required power for propulsion for the vehicles connected to the conductor segment exceeds the maximum power available via said conductor segment, the CECU adjusts the power to be received for one or more of the vehicles to a lower value that the corresponding required power for propulsion at the target speed provided that the one or more vehicles have sufficient energy storage status to compensate for the lower received power. For some vehicles, having a high energy storage status, the power to be received me be as low as zero. For other vehicles, having a low energy storage status, the power to be received may be equal to, or close to, the required power for propulsion.

In embodiments, the power to be received for each vehicle is determined such that each vehicle is able to propel, for instance at said target speed, along the full length of the conductor segment to which said vehicle is connected. This embodiment differs from the embodiment above in that the CECU also takes into account the length of the conductor segment. For example, the CECU may determine, based on the current energy storage status and the required power for propulsion at the target speed, a minimum required power to be received for each vehicle to be able to propel the full remaining length of the conductor segment. If the sum of the required power for propulsion for the vehicles connected to the conductor segment exceeds the maximum power available via said conductor segment, the CECU may adjust the power to be received for one or more of the vehicles to a lower value that the corresponding required power for propulsion at the target speed provided, provided that the lower value is above the determined minimum required power. Once the vehicle reaches a subsequent conductor segment, a new determination of minimum required power may be conducted.

In embodiments, the CECU is configured to determine a desired target speed for each vehicle, and to send at least one speed control signal to each VECU indicating said desired target speed, and wherein said VECU is configured to adjust its target speed in response to said at least one speed control signal. The CECU may be further configured to, if the sum of the powers to be received for each vehicle connected to a conductor segment exceeds the maximum power for said conductor segment, reduce the speed of one or more vehicles by lowering said desired target speed for at least one vehicle connected to said conductor segment. This embodiment is advantageously combined with the above-described embodiment where the power to be received for each vehicle is determined such that each vehicle is able to propel at said target speed along the full length of the conductor segment to which said vehicle is connected. In such a combined embodiment, the CECU primarily attempts to determine a power to be received for each vehicle such that they can propel at the present target speed along the full length of the conductor segment to which said vehicle is connected, for example in the manner exemplified above. If this is not possible, the CECU may determine a new desired target speed for each vehicle, being lower than the present target speed of one or more of the vehicles, and to send at least one speed control signal to each VECU indicating said desired target speed. Based on an iterative process, the target speeds may be reduced until it is determined that each vehicle is able to propel at its target speed along the full length of the conductor segment.

In embodiments, the CECU is configured to determine a desired end position for each vehicle, and to determine a current location for each vehicle, wherein said CECU is configured to execute a learning or predictive control algorithm configured to determine the power to be received for each vehicle and the desired target speed for each vehicle to minimize the time for each vehicle to reach its desired end position while not exceeding the maximum power available for each conductor segment. For instance, a model predictive control (MPC) algorithm can be used, where a target speed for each vehicle and each conductor segment constitutes one set of optimization variables, and a power to be received for each vehicle and each conductor segment constitutes a further set of optimization variables, and where the cost function for example is a sum of the squared times for each vehicle to reach its desired end position. The power to be received and the target speed for each vehicle may be constant over a given conductor segment, resulting in a simplified discrete MPC algorithm. The time for a vehicle to reach its desired end position may be determined as the sum of the times needed to propel along the conductor segments (or portions thereof) remaining up to the desired end position. The time needed to propel along a conductor segment (or portion thereof remaining) may be modelled in a simplified manner as the length of the conductor segment (or portion thereof remaining) divided by the target speed of the vehicle for this conductor segment (assuming a constant target speed).

In embodiments, the algorithm is further configured to determine said power to be received and said target speed for each vehicle such that the energy storage status (battery charge status for instance) for each vehicle is substantially full at respective end positions. In such an embodiment, the cost function further comprises a function penalizing deviation from full energy storage status for each vehicle.

In embodiments, the VECU is configured to send a load carrying signal to the CECU indicating a priority of the load content in the vehicle, and wherein said algorithm is further configured to determine said power to be received and said target speed for each vehicle further based on said load carrying signals such that vehicles carrying load content having high priority reaches the respective end positions faster than vehicles carrying load content having lower priority. In such an embodiment the cost function may comprise weighting coefficients calculated in response to the load carrying signals from each vehicle. In other words, the modelled time to reach a desired end position for a vehicle having a load of high priority is provided with a higher weighting coefficient in the cost function than the modelled time of another vehicle having a load of lower priority.

In embodiments, the maximum power available via said conductor segment or segments is determined on a basis of power draw from adjacent conductor segments and available power for the electric conductor as a whole. The conductor segments are normally connected to a main electric conductor line via respective switches, and the maximum power available for a given conductor segment is thus dependent on the power draw of adjacent conductor segments in relation to the available power for the electric conductor as a whole.

In embodiments, the VECU's and the CECU are configured for two-way communication with each other via said at least one electric conductor. In other words, the CECU communicates with the VECU's via the electric conductor and the current collector. Alternatively, the VECU and CECU are configured for wireless two-way communication. The VECU's may be comprises or be connected to wireless communication means configured for the wireless two-way communication. Wireless communication means suitable for this application are well known in the art and will not be described in further detail here.

In embodiments where at least one of the at least one electric conductor is formed by consecutively arranged conductor segments, the CECU is configured to determine locations of the at least two electrically powered vehicles by means of determining which conductor segment the vehicle is connected to. The conductor segments are normally connected to a main electric conductor line via respective switches, which switches are advantageously used to determine the locations.

In embodiments, the VECU of at least one vehicle comprises a configurable interface adapted to connect to one or more already existing electronic control units of the vehicle, said interface being configurable to distribute power to the vehicle as per manufacturers specified requirement.

In embodiments, at least one of the vehicles comprises at least one position sensor connected to the VECU and being arranged to sense the relative lateral position between the at least one electric conductor and the vehicle, wherein said vehicle comprises autonomous steering means configured to co-act with the VECU to autonomously steer the vehicle in response to a signal from said at least one position sensor such that the vehicle follows the at least one electric conductor. In other words, the VECU steers the vehicle to follow the electric conductor/conductor segments. The autonomous steering means may comprise the (normally already present) electric steering device co-acting with the electronic control unit of the vehicle. The at least one vehicle may comprise autonomous driving means being configured to co-act with said VECU to accelerate and/or decelerate the vehicle in response to said at least one speed control signal received by said VECU. The autonomous driving means may be in the form of an algorithm in the already present electric control unit of the vehicle, which controls the vehicle speed by controlling the power output to the electric motor(s) of the vehicle. In embodiments, the at least one position sensor may comprise means for generating a magnetic field and means for sensing a variation of a generated magnetic field, the means for generating and the means for sensing being attached directly or indirectly to the current collector, wherein the means for sensing is configured to generate a signal correlated to a horizontal/lateral distance between the means for generating a magnetic field and the at least one electric conductor. The means for generating and sensing a magnetic field may comprise coils as described in applicants' patent EP2552735B1. In other embodiments, the arrangement comprises one or more optical sensors configured to generate a signal corresponding to the horizontal distance between the current collector and the at least one electric conductor and/or a discrete signal indicating if the current collector is laterally aligned with the at least one electric conductor or not.

According to a second aspect of the invention, there is provided a method for controlling a system for electrically feeding electrically powered vehicles. The system comprises at least one electric conductor adapted to be electrically energized and extending along a road section on which the at least one vehicle is adapted to travel, and at least two electrically powered vehicles, each comprising an energy storage device (a battery set for instance) and at least one current collector adapted to connect the vehicle electrically to said at least one electric conductor. The method comprises:
determining a current required power for propulsion of the vehicle;
determining a current energy storage status of said energy storage device (a current battery charge status of a battery set for instance);
determining a maximum power available or obtainable from said electric conductor;
determining, based on said current required power and current energy storage status for each vehicle, a power to be received for each vehicle such that the maximum power is not exceeded while each vehicle maintains its target speed, and
controlling, for each vehicle, a received power via the current collector corresponding to the determined power.

In embodiments of the method according to the second aspect of the invention, the method comprises determining a current required power for propulsion of the vehicle at a target speed, and determining, based on said current required power and current energy storage status for each vehicle, a power to be received for each vehicle such that the maximum power is not exceeded while each vehicle maintains its target speed.

The features of the embodiments described above are combinable in any practically realizable way to form embodiments having combinations of these features. Further, all features and advantages of embodiments described above with reference to the first aspect of the invention may be applied in corresponding embodiments of the second aspect of the invention.

### BRIEF DESCRIPTION OF THE DRAWINGS

Above discussed and other aspects of the present invention will now be described in more detail using the appended drawings, which show presently preferred embodiments of the invention, wherein:

FIG. 1 shows a schematic side view illustration of an embodiment of the system according to the first aspect of the invention;

FIG. 2 shows a top view illustration of parts of the system in FIG. 1;

FIG. 3 shows a schematic side view illustration of another embodiment of the system according to the first aspect of the invention, and

FIG. 4 shows a flowchart of an embodiment of the method according to the second aspect of the invention.

### DETAILED DESCRIPTION

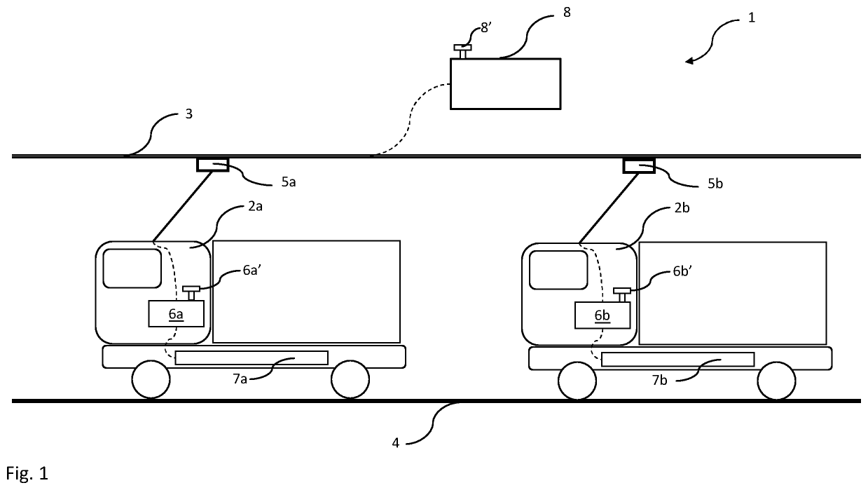

FIG. 1 shows a schematic side view illustration of an embodiment of the system according to the first aspect of the invention. The system 1 comprises an electric conductor 3 suspended above and extending along a road section 4 on which electrically powered vehicles 2a, 2b travel. A central electronic control unit, CECU, 8 is electrically connected to the electric conductor 3. The vehicle 2a comprises a current collector 5a connecting the vehicle electrically to the electric conductor 3, and a vehicle electronic control unit, VECU, 6a being electrically connected to the current collector 5a, where the VECU is connected to a battery set 7a of the vehicle. The current collector 5a is connected to the vehicle roof by means of at least one elongated arm configured to displace the current collector laterally and vertically to connect with the electric conductor 3. The electrically powered vehicle 2a is configured to be electrically propellable by means of electric power from its battery set 7a and/or from the current collector 5a. The VECU and CECU are configured for two-way wireless electric communication with each other using wireless communication modules, here illustrated (greatly exaggerated in size) as antenna elements 6a′, 8′. The second vehicle 2b comprises a corresponding current collector 5b, VECU 6b with wireless communication module 6b′ and battery set 7b as the first vehicle 2a.

Each VECU is configured to determine a current required power for propulsion of the vehicle, which current required power may correspond to the required power for propulsion at the present speed of the vehicle or at a target speed, and a current battery charge status of said battery set, and to send at least one signal to the CECU indicating said current required power and said battery charge status. The CECU 8 is configured to determine a maximum power available via said electric conductor 3, and to, based on said at least one signal from each VECU, 6a, 6b determine a power to be received for each vehicle 2a, 2b such that the maximum power is not exceeded, and send at least one power control signal to each VECU 6a, 6b indicating said power to be received. Each VECU 6a, 6b is furthermore configured to control received power via the current collector 5a, 5b in response to the at least one power control signal.

In an example, the vehicles 2a, 2b propel at the same speed V. Since the vehicles are identical and carry the same load, the current required power P_{req} is also the same for both vehicles. This current required power is determined by the respective VECU (having knowledge of currently used power by means of signals received from the vehicle). The first vehicle has a battery charge status of 0%, while the second vehicle has 100%. The VECU's each send a signal to the CECU indicating these figures. The CECU determines that the maximum power available P max from the conductor is less than 2*P_{req}. Based on the charge status for the first vehicle, the CECU determines that its power to be received P_{rec1} must be at least P_{req}. Based on the charge status for the second vehicle, the CECU determines that its power to be received P_{rec2} can be less than P req. The CECU may for example be configured to use an algorithm attempting to achieve balanced battery charge status of all vehicles, and therefore determines that P_{rec1}=Pₘₐₓ and P_{rec2}=0. The CECU sends a power control signal to each VECU 6a, 6b indicating the respective power to be received. Each VECU 6a, 6b controls received power via the current collector 5a, 5b in response to the power control signal. The algorithm repeats this determination continuously, and eventually, when the battery charge statuses of the vehicles are equal, the second vehicle will start receiving power via its current collector.

The CECU 8 is furthermore configured to optionally determine a desired target speed for each vehicle 2a, 2b, and to send at least one speed control signal to each VECU 5a, 5b indicating said desired target speed. This functionality may be used to reduce the speed of one or more vehicles by lowering said desired target speed for at least one vehicle connected to said conductor segment. Assuming for instance that two vehicles are connected to the electric conductor, and that the battery charge status of both vehicles is 0%, then the sum of the current required powers P_{rec1}+P_{rec2} for the vehicles to propel at their respective present target speeds may exceed Pₘₐₓ, which makes propulsion at the present target speeds impossible. In such a case, the CECU may determine lower desired target speeds for the vehicles and send speed control signals to the VECU's such that propulsion is possible without exceeding the capacity of the electric conductor.

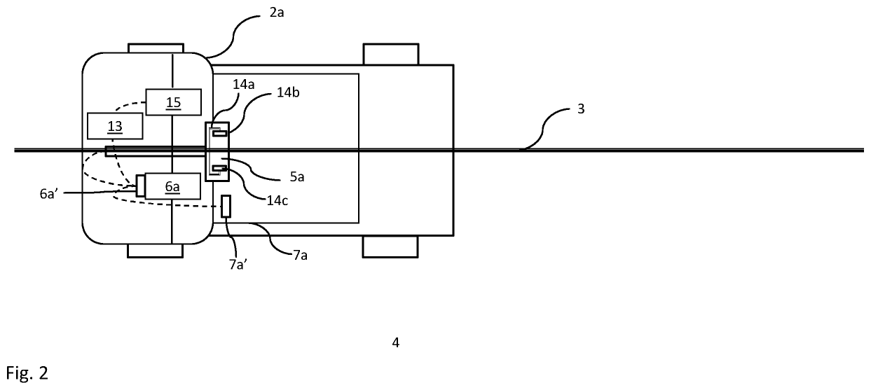

FIG. 2 shows a top view illustration of parts of the system in FIG. 1. The vehicle 2a comprises a current collector 5a being provided with a position sensor 14a-c connected to the VECU 6a and being arranged to sense the relative position between the electric conductor 3 and the vehicle 2a. The position sensor comprises a coil 14a for generating a magnetic field and laterally spaced apart coils 14b, 14c for sensing a variation of the generated magnetic field to generate a signal correlated to a horizontal distance between coil 14a and the at least one electric conductor. Such a configuration with three coils is disclosed in applicants' patent EP2552735B1 and will not be described in further detail here. The vehicle 2a comprises autonomous steering means in the form of an (already present) electronic control unit 13 of the vehicle and a thereto electronically controlled steering device/actuator 15, which are electrically connected to and configured to co-act with the VECU 6a to autonomously steer the vehicle in response to a signal from the position sensor 14a-c such that the vehicle follows the at least one electric conductor. In other words, the VECU steers the vehicle to follow the electric conductor/conductor segments. The vehicle 2a further comprises autonomous driving means in the form of an algorithm in the already present electric control unit 13 of the vehicle, which controls the vehicle speed by controlling the power output to electric motors of the vehicle to accelerate and/or decelerate the vehicle in response to the at least one speed control signal received by said VECU.

FIG. 2 further illustrates that the VECU 6a is indirectly connected to the battery set 7a via a battery management system, BMS, 7a′ which is arranged to monitor the charge status and health status of each battery cell of the battery set.

FIG. 2 further illustrates that the VECU 6a comprises a user-configurable interface 6a′ which in this embodiment is configured to connect to the electronic control unit 13, the current collector 5a and to the BMS 7a′.

Vehicle 2b shown in FIG. 1 comprises the same features as vehicle 2a described above with reference to FIG. 2.

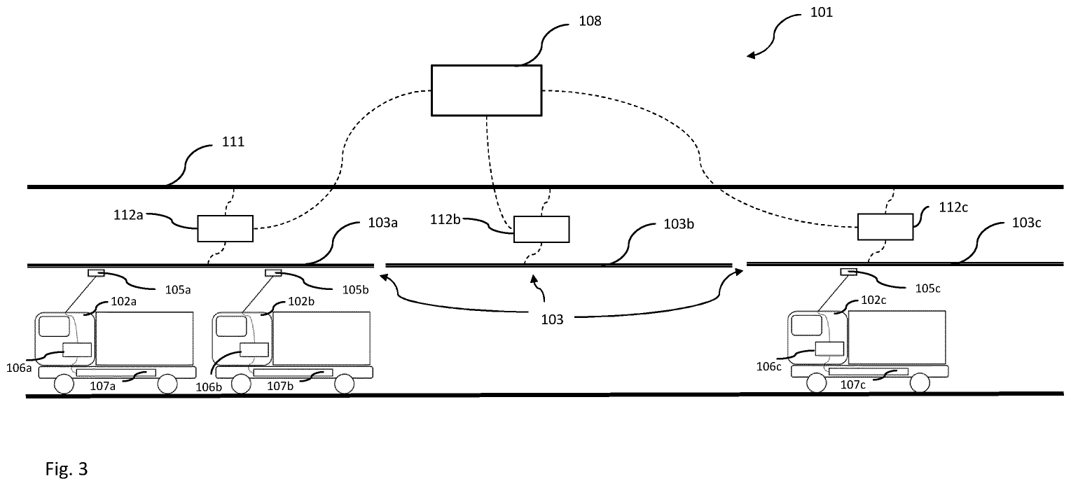

FIG. 3 shows a schematic side view illustration of another embodiment of the system according to the first aspect of the invention. The system 101 corresponds to that shown in FIGS. 1-2 and described above in the sense that it comprises an electric conductor 103 suspended above and extending along a road section 104 on which electrically powered vehicles 102a, 102b, 102c travel, and in that a central electronic control unit, CECU, 108 is electrically connected to the electric conductor 103. The vehicles 102a-c correspond to vehicles 2a-b in FIG. 1 in that they each comprise a current collector 105a-c, a vehicle electronic control unit, VECU, 106a-c and a battery set 107a-c.

The system in FIG. 3 however differs from the system in FIG. 1-2 in several ways. Firstly, the electric conductor 103 is formed from three consecutively arranged electric conductor segments 103a-c. Each conductor segment is connected to a source of electric power 111, here illustrated in the form of a main electric conductor line, via respective switches 112a-c. Secondly, the VECU and CECU are configured for two-way electric communication with each other via the electric conductor, i.e. via conductor segments 103a-c and switches 112a-c. Another embodiment corresponds to the embodiment in FIG. 3 except that the VECU and CECU communicate wirelessly as in FIG. 1.

The CECU 108 is configured to determine which conductor segment or segments 103a-c the vehicles 102a-c are connected to, and to determine a maximum power available Pₘₐₓ₁, Pₘₐₓ₂, Pₘₐₓ₃ for the respective conductor segments, and to determine the power to be received P_{rec1}, P_{rec2}, P_{rec3} for each vehicle such that the maximum power for each conductor segment is not exceeded while each vehicle maintains its target speed. The maximum power available Pₘₐₓ₁, Pₘₐₓ₂, Pₘₐₓ₃ for the respective conductor segments is determined based on global constraints such that the overall power available via main electric conductor line 111, and further based on local constraints such that the power draw of adjacent conductor segments.

The CECU 108 is configured to determine a location of the vehicles 102a-c by means of determining which conductor segment 103a-c the vehicle is connected to. This is determined using status signals obtained from the switches 112a-c and/or a status signal from the vehicles indicating which switch the vehicle is connected to.

The CECU 108 is furthermore configured to determine the power to be received P_{rec1}, P_{rec2}, P_{rec3} for each vehicle such that each vehicle is able to propel at said target speed along the full length of the conductor segment to which said vehicle is connected. The power to be received for each vehicle is determined by first determining, based on the current charge status and the required power for propulsion at the target speed, the minimum required power P_{req1min}, P_{req2min}, P_{req3min} to be received for each vehicle to be able to propel the full remaining length of the conductor segment. This calculation is further based on known information regarding the lengths of the conductor segments and the determined locations of the vehicles. The CECU 8 is furthermore configured to determine a desired target speed for each vehicle 102a-c in a corresponding manner as described above with reference to FIG. 1. In the above-mentioned determination, the power to be received and minimum required power for each vehicle are assumed to be constant over the length of the respective conductor segment.

In an example where the sum of the required powers P_{req1}, P_{req2} for propulsion of the vehicles 102a, 102b connected to the conductor segment 103a exceeds the maximum power available Pₘₐₓ₁ via said conductor segment, the CECU 108 may adjust the powers to be received P_{rec1}, P_{rec2} for the vehicles to a lower value that the corresponding required powers P_{req1}, P_{req2} for propulsion at the target speed provided, provided that the lower value is above the determined minimum required power P_{req1min}, P_{req2min}. Once the vehicle reaches a subsequent conductor segment, a new determination of minimum required power is conducted. In an example where one or more of the determined required powers P_{req1}, P_{req2} is/are below P_{req1min}, P_{req2min}, the CECU determines a new desired target speed for the vehicle(s), being lower than the present target speed of one or more of the vehicles, and sends at least one speed control signal to the VECU(s) indicating said desired target speed. Based on an iterative process, the target speed(s) is/are reduced until it is determined that each vehicle is able to propel at its target speed along the full length of the conductor segment.

The CECU 108 is furthermore configured to optionally determine a desired end position for each vehicle 102a-c, wherein the CECU is configured to execute a discrete model predictive control (MPC) algorithm, where a target speed for each vehicle and each conductor segment constitutes one set of optimization variables, and a power to be received for each vehicle and each conductor segment constitutes a further set of optimization variables, and where the cost function is a sum of the squared time for each vehicle to reach its desired end position. The power to be received and the target speed for each vehicle is constant over a given conductor segment. The algorithm is further configured to determine said power to be received and said target speed for each vehicle such that the charge status for each vehicle is substantially full at respective end positions. This is achieved by means of the cost function further comprising a function penalizing deviation from full battery charge status for each vehicle. The desired end position may for example be to the left in the figure, where vehicle 102a is already positioned. The time for a vehicle to reach its desired end position is determined as the sum of the times needed to propel along the conductor segments (or portions thereof) remaining up to the desired end position. The time needed to propel along a conductor segment (or portion thereof remaining) is modelled in a simplified manner as the length of the conductor segment (or portion thereof remaining) divided by the target speed of the vehicle for this conductor segment (assuming a constant target speed).

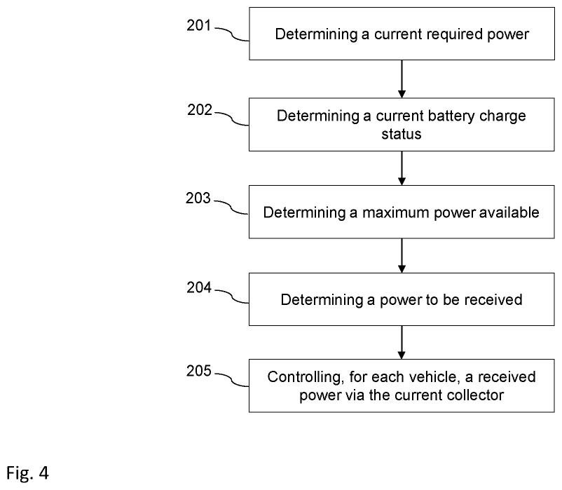

FIG. 4 shows a flowchart of an embodiment of the method according to the second aspect of the invention. The method comprises determining 201 a current required power for propulsion of the vehicle at a target speed, determining 202 a current battery charge status of said battery set, determining 203 a maximum power available via said electric conductor, determining 204, based on said current required power and current battery charge status for each vehicle, a power to be received for each vehicle such that the maximum power is not exceeded while each vehicle maintains its target speed, and controlling 205, for each vehicle, a received power via the current collector corresponding to the determined power. The method steps may be performed by a CECU and VECU's in a corresponding manner described above with reference to FIGS. 1-3.

The description above and the appended drawings are to be considered as non-limiting examples of the invention. The person skilled in the art realizes that several changes and modifications may be made within the scope of the invention. For example, in FIGS. 1/3, the electric conductor is shown suspended above the road surface. Other embodiments are identical to those of FIGS. 1/3, except for that the electric conductor is recessed in the road surface and the current collector is arranged for connection with the recessed electric conductor, for example as shown in WO 2010/140964. In FIGS. 1/3, the CECU 8/108 is shown as stationary, i.e., is located at a fixed location and being electrically connected to the (also) stationary electric conductor. In other embodiments, the CECU may be non-stationary, for instance being located on one of the vehicles. The electric conductor in FIG. 3 is shown as being formed by three conductor segments, but may in other embodiments comprises additional (or fewer) conductor segments. In the embodiments above, the energy storage devices are in the form of battery sets. These battery sets may be replaced with other types of energy storage devices such as hydraulic accumulators, flywheels or supercapacitors.

1.-17. (canceled)

18. System for electrically feeding electrically powered vehicles, comprising:
at least one electric conductor adapted to be electrically energized and extending along a road section on which the at least one vehicle is adapted to travel;
at least two electrically powered vehicles, each comprising at least one current collector adapted to connect the vehicle electrically to said at least one electric conductor, and a vehicle electronic control unit (VECU) being electrically connected to said current collector, said VECU being directly or indirectly connected to an onboard energy storage device of said vehicle; and
a central electronic control unit (CECU),
wherein said VECU and CECU are configured for communication with each other, wherein each VECU is configured to determine a current required power for propulsion of the vehicle and a current energy storage status of said energy storage device, and to send at least one signal to the CECU indicating said current required power and said energy storage status,
wherein said CECU is configured to determine a maximum power available, and to, based on said at least one signal from each VECU, determine a power to be received for each vehicle such that a maximum power is not exceeded, and send at least one power control signal to each VECU indicating said power to be received, and
wherein said VECU is configured to control received power via the current collector in response to said at least one power control signal.

19. System according to claim 18, wherein at least one of said at least one electric conductor is formed by consecutively arranged conductor segments, wherein said CECU is configured to determine which conductor segment or segments the vehicles are connected to, and to determine a maximum power available from said conductor segment or segments, and to determine said power to be received for each vehicle such that the maximum power for each conductor segment is not exceeded.

20. System according to claim 19, wherein said power to be received is determined such that each vehicle is able to propel along the full length of the conductor segment to which said vehicle is connected.

21. System according to claim 18, wherein each VECU is configured to determine said current required power for propulsion of the vehicle at a target speed, and wherein the CECU is configured to determine said power to be received for each vehicle such that the maximum power is not exceeded while each vehicle maintains its target speed.

22. System according to claim 21, wherein said CECU is configured to determine a desired target speed for each vehicle, and to send at least one speed control signal to each VECU indicating said desired target speed, and wherein said VECU is configured to adjust its target speed in response to said at least one speed control signal.

23. System according to claim 22, wherein said CECU is configured to, if the sum of the powers to be received for each vehicle connected to a conductor segment exceeds the maximum power for said conductor segment, reduce the speed of one or more vehicles by lowering said desired target speed for at least one vehicle connected to said conductor segment.

24. System according to claim 22, wherein said CECU is configured to determine a desired end position for each vehicle, and to determine a current location for each vehicle, wherein said CECU is configured to execute a learning or predictive control algorithm configured to determine the power to be received for each vehicle and the desired target speed for each vehicle to minimize the time for each vehicle to reach its desired end position while not exceeding the maximum power available for each conductor segment.

25. System according to claim 24, wherein said algorithm is further configured to determine said power to be received and said target speed for each vehicle such that the energy storage status for each vehicle is substantially full at respective end positions.

26. System according to claim 24, wherein said VECU is configured to send a load carrying signal to the CECU indicating a priority of the load content in the vehicle, and wherein said algorithm is further configured to determine said power to be received and said target speed for each vehicle further based on said load carrying signals such that vehicles carrying load content having high priority reaches the respective end positions faster than vehicles carrying load content having lower priority.

27. System according to claim 22, wherein said vehicle comprises autonomous driving means being configured to co-act with said VECU to accelerate and/or decelerate the vehicle in response to said at least one speed control signal received by said VECU.

28. System according to claim 18, wherein said VECU and CECU are configured for two-way communication with each other via said at least one electric conductor.

29. System according to claim 18, wherein each VECU and said CECU each comprise wireless communication means configured for wireless two-way communication between said VECU and CECU.

30. System according to claim 18, wherein at least one of said at least one electric conductor is formed by consecutively arranged conductor segments, and wherein said CECU is configured to determine a location of the at least one electrically powered vehicle by means of determining which conductor segment the vehicle is connected to.

31. System according to claim 30, wherein said conductor segments are connected to a source of electric power via respective switches, wherein said CECU is arranged in communication with said switches, and wherein said location is determined using at least one status signals from the switches.

32. System according to claim 18, wherein said VECU comprises a configurable interface adapted to connect to one or more already existing electronic control units of the vehicle.

33. System according to claim 18, wherein at least one of said vehicles comprises at least one position sensor connected to the VECU and being arranged to sense the relative position between the at least one electric conductor and the vehicle, wherein said vehicle comprises autonomous steering means configured to co-act with the VECU to autonomously steer the vehicle in response to a signal from said at least one position sensor such that the vehicle follows the at least one electric conductor.

34. Method for controlling a system for electrically feeding electrically powered vehicles, said system comprising:
at least one electric conductor adapted to be electrically energized and extending along a road section on which the at least one vehicle is adapted to travel; and
at least two electrically powered vehicles, each comprising an onboard energy storage device and at least one current collector adapted to connect the vehicle electrically to said at least one electric conductor,
said method comprising:
determining a current required power for propulsion of the vehicle;
determining a current energy storage status of said energy storage device;
determining a maximum power available;
determining, based on said current required power and current energy storage status for each vehicle, a power to be received for each vehicle such that a maximum power is not exceeded; and
controlling, for each vehicle, a received power via the current collector corresponding to the determined power.
